(19) United States
(12) Patent Application Publication
(10) Pub. No.: US 2026/0044850 A1
(43) Pub. Date: Feb. 12, 2026

(54) Secure payment method

(71) Applicant: CHEQs Global Ltd, London (GB)

(72) Inventors: Richard Piacentini, Chonburi (TH); Keir Finlow-Bates, Satakunta (FI)

(21) Appl. No.: 19/291,861

(22) Filed: Aug. 6, 2025

(30) Foreign Application Priority Data
Aug. 7, 2024 (GB) 2411624.6

(51) Int. Cl. G06Q 20/38; G06Q 20/40

(52) U.S. Cl. CPC G06Q 20/3825; G06Q 20/401

(57) ABSTRACT

Methods, systems and software designs are disclosed that may be used to enable simple, safe and secure transfers of digital assets such as cryptocurrencies, fungible tokens, and non-fungible tokens (NFTs) from a transferor to a recipient through a payment channel established by a smart contract on a blockchain. Transfers are enacted by the recipient presenting a voucher to the smart contract, said voucher being digitally signed by the transferor and transmitted to the recipient at a prior date and time. The voucher may be transmitted through an out-of-band channel, for example, through email, or a messenger application, and may take the form of a quick-response code (QR code), a base 64 encoded string, a hexadecimal string or some other representation. The smart contract may impose limitations on a minimum and/or maximum amount that may be transferred, and on a time period in which the voucher may be redeemed.

### CROSS-REFERENCE TO RELATED APPLICATIONS

This application claims priority under 35 U.S. C. § 119(a)-(d) to the United Kingdom of Great Britain Patent Application No. 2411624.6, titled “Secure payment method” by Richard Piacentini and Keir Finlow-Bates, filed on 7 Aug. 2024, the entire contents of which are hereby incorporated by reference.

### BACKGROUND OF THE INVENTION

Decentralized software development has advanced significantly over the past fifteen years with the advent of blockchain technology. In blockchains, multiple unaffiliated entities validate and extend a ledger through a consensus system, incentivizing these entities to maintain an honest, transparent, and open network. The ledger is typically used to instantiate digital assets such as fungible tokens, non-fungible tokens (NFTs), and/or cryptocurrency, and to record ownership of the digital assets. The decentralized software is organized and manipulated using mathematical transformations such as digital signing algorithms and cryptographic hash functions that cannot be altered without the assistance of a plurality of computer processing systems (for example, controllers such as microprocessors). The complexity and frequency of these manipulations are substantially beyond the capabilities of human calculation, even with the aid of pen and paper. Blockchains are typically immutable, that is to say, the transfer of digital assets from one entity to another cannot be reversed after the fact.

### SUMMARY OF THE INVENTION

Due to the immutable nature of blockchains, the transfer of digital assets from one entity to another is fraught with risks not seen in conventional asset transfers, as transactions may be effectively irreversible. For example, if a transferor transfers an amount of a token on Ethereum, such as USDC or USDT, to the wrong Ethereum address or an address not in use, the transferor cannot retrieve the amount of the token and a recipient expecting a payment may reasonably consider the payment not made. The same applies to native cryptocurrencies such as bitcoin on the Bitcoin blockchain, ether on the Ethereum blockchain, and most other cryptocurrencies and blockchain instantiated tokens.

Addresses may be incorrectly supplied by the recipient expecting a payment, mistyped by the transferor, copied incorrectly, either through transferor error or due to malware inspecting a copy clipboard and surreptitiously altering clipboard strings determined to contain blockchain addresses, scanned incorrectly from a quick-response code (QR code) or bar code by a device, or incorrectly selected from a list of contacts. Malicious parties are also known to generate a vanity blockchain address resembling a legitimate address, for example, by matching the same first and last five or six characters of the legitimate address to trick the transferor into transferring assets to the vanity address instead.

There is therefore a need for a system and method whereby a transferor can reliably and securely transfer assets to a recipient in a simple, user-friendly, and reliable manner. In the present disclosure, systems and methods for providing reliable, trustworthy, and risk-free transfers of digital assets such as cryptocurrencies and blockchain tokens are presented through the use of a payment channel and a digital voucher system. The present disclosure is applicable to but not limited to cryptocurrencies, fungible tokens, non-fungible tokens (NFTs) and all blockchain-based exchange, payment, and information systems.

Increasing the reliability and trustworthiness of payment transfers has the advantage of preventing assets or funds from being transferred to the wrong recipient and potentially lost. Systems and methods disclosed herein therefore have the advantage of reducing a rate of transaction errors and thereby reducing accidental loss of funds.

Additionally, incorrect transactions may require investigation and correction, which may for example take the form of further transactions. These further transactions consume processor and network resources that would have been saved had the incorrect transactions been avoided. Systems and methods disclosed herein therefore have the further advantage of saving processor and network resources by avoiding the need for unnecessary work following errors.

Furthermore, increased error detection mitigates the risk of a malicious party providing false information to make a fraudulent transaction, as the malicious party is less likely to meet the requirements of the error detection process. Systems and methods disclosed herein therefore have the further advantage of increased security and reduced vulnerability to malicious third parties.

A computer-implemented system for processing a payment of a digital asset from a transferor to a recipient by a smart contract using a digitally signed voucher is disclosed.

The system may comprise at least one device connected to a blockchain on a network, the at least one device comprising a hardware processor for retrieving and executing instructions encoded in a smart contract computer program for instantiating a payment channel between the transferor and the recipient. The transferor may transfer the digital asset to the smart contract or cause the device to transfer the digital asset to the smart contract. The smart contract adds a record of the digital asset against the payment channel, to the benefit of the recipient who can inspect the blockchain and see that funds covering future payments are reserved through ownership by the smart contract. Subsequently, the transferor generates a digitally signed voucher for the payment and transfers the digitally signed voucher to the recipient. The recipient then presents the digitally signed voucher to the smart contract. On determining that the digitally signed voucher presented is valid, the smart contract transfers the digital asset to the recipient and removes the record of the digital asset from the payment channel. Those skilled in the art will now appreciate that the digitally signed voucher and smart contract ensure that payment is made from the transferor to a correct address of the recipient, removing the risk of addressing errors previously highlighted.

According to an aspect of the present disclosure there is presented a method of processing a payment of a digital asset from a transferor to a recipient by a smart contract using a digitally signed voucher, the method comprising: instantiating a payment channel between the transferor and the recipient; transferring the digital asset to the smart contract; adding a record of the digital asset against the payment channel; generating a digitally signed voucher for the payment; transferring the digitally signed voucher to the recipient; and presenting the digitally signed voucher to the smart contract, and wherein on determining that the digitally signed voucher presented is valid, the smart contract transfers the digital asset to the recipient and removes the record of the digital asset from the payment channel.

This method provides increased certainty that payments are not accidentally made to the wrong address. In particular, the step of the smart contract determining whether the digital voucher is valid allows errors to be detected and avoided before a potentially irrevocable transaction is made. Furthermore, this method is superior to a traditional blockchain transaction submitted by the transferor to either the blockchain or to the recipient for submission by the recipient to the blockchain for multiple reasons, including: the smart contract provides a transparent inspectable guarantee to the recipient that funds are available to cover the payment, the digital voucher poses no risk if information in the voucher is inaccurate, for example but not limited to, if the recipient address in the voucher is wrong the digital voucher becomes valueless and will have no effect on a state of the smart contract or balances of the transferor and/or recipient whereas if information in a traditional blockchain transaction is inaccurate the traditional blockchain transaction remains valid and may, for example but not limited to, transfer assets from the transferor to an entity other than the recipient. Thus the digital voucher can be safely transferred over an open channel, for example but not limited to, email, a quick-response code (QR code), or a text message, whereas a traditional blockchain transaction should be transmitted over a secure channel, for example an encrypted channel, thus precluding the use of QR codes. Therefore the above method allows for more reliable payments, reducing the risk of errors and incorrect transfer of funds, and further provides improved payment security even when used via an open channel.

The digitally signed voucher may comprise a sequence number, and the smart contract may comprise a current sequence number. The smart contract may determine that the digitally signed voucher is invalid if the sequence number is not equal to the current sequence number. The current sequence number may be incremented after the smart contract has determined that the digitally signed voucher presented is valid. Sequence numbers provide additional benefits and advantages over present known methods, for example but not limited to, allowing the transferor to issue out-of-sequence digitally signed vouchers to the recipient. This provides the transferor and recipient with provisional payments. For example, presented for illustrative purposes only and not meant to be limiting in any way, a transferor and recipient may contractually agree to a plurality of tasks, such as N tasks, to be performed by the recipient for payment by the transferor. On completion of a first task the transferor may present a first digitally signed voucher with sequence number 2, on completing a second task the transferor may present a second digitally signed voucher with sequence number 3, and so on through to completion of a (N-1)th task for which the transferor may present an (N-1)th digitally signed voucher with sequence number N. Those skilled in the art will appreciate that at this point the recipient cannot redeem the N-1 digitally signed vouchers they have received. Finally, on completion of an Nth task the transferor may present an Nth digitally signed voucher with sequence number 1. Those skilled in the art will now appreciate that by redeeming the Nth digitally signed voucher all prior digitally signed vouchers become redeemable.

The digitally signed voucher may comprise a validity date and time. In some embodiments of the present system, the smart contract may determine that the digitally signed voucher is invalid if the validity date and time is before a current date and time. In other embodiments of the present system, the smart contract may determine that the digitally signed voucher is invalid if the validity date and time is after a current date and time. This allows errors relating to the accidental reuse of earlier payment information to be detected before a transaction is made, potentially allowing the transaction to be rejected and/or canceled before becoming irrevocable. It also provides advantages in that digitally signed vouchers can easily be post dated, a functionality currently requiring the construction of complex transactions and/or one off smart contracts in the current state of the art, thereby improving the flexibility of the payment method and its adaptability to different situations and applications.

The payment channel may comprise an expiration date and time, and the smart contract may determine that the digitally signed voucher is invalid if the digitally signed voucher is presented after the expiration date and time. This provides additional benefits to transferors. For example returning to the above illustrative example using out-of-sequence digital vouchers, a transferor and recipient may contractually agree to a plurality of tasks being completed by a specified date and time. By issuing digitally signed vouchers with an expiration date and time corresponding to the specified date and time, if the recipient does not complete the tasks on time, the digitally signed vouchers become invalid and the recipient cannot claim payment in accordance the contractual agreement.

The digitally signed voucher may comprise a digital signature of a portion of the digital voucher, said digital signature generated by the transferor, and the smart contract may determine that the digitally signed voucher is invalid if the digital signature is invalid.

The digitally signed voucher may comprise a numerical amount of the digital asset, and the smart contract may determine that the digitally signed voucher is invalid if a balance of the digital asset recorded against the payment channel is less than the numerical amount. This provides budgeting advantages to the transferor and recipient, in that amounts for payment can be allocated in advance. Additionally, reducing the risk of an incorrect payment amount improves the reliability of payments being made correctly.

In some embodiments of the present system, the transferor may be identified by a first blockchain address, and the recipient may be identified by a second blockchain address.

The digital asset may comprise: an amount of a fungible token, one or more non-fungible tokens (NFTs), and/or a cryptocurrency, thus allowing payment to be made with digital assets of commercial value, and/or digital assets that are desirable to the recipient, for example but not limited to, for artistic reasons such as collectible or art NFTs, or utilitarian reasons such as governance tokens, thereby improving the flexibility of the payment method and its adaptability to different situations and applications.

The payment channel may comprise a mapping from the transferor, the recipient, and a channel number to a payment channel data structure instance. In some embodiments the mapping may comprise or be structured as a mapping from a transferor address to a mapping from a recipient address to a mapping from a channel number to a payment channel data structure instance.

The payment channel data structure instance may comprise a token type, a balance of the token type, a cumulative deposit total of the token type, a sequence number, a creation date, and/or an expiration date.

The token type may comprise a token data structure instance, and the token data structure instance may comprise a token identity, a minimum token deposit amount, and/or a maximum token deposit amount. This provides advantages to the transferor and/or the recipient in that budgeting amounts for payment including possible extensions to budgets may be transparently and immutably locked down in advance, thereby providing increased reliability and certainty and reducing the risk of fraud.

The token identity may be a blockchain address of a smart contract instantiating the token type. The token type may be one or more of a fungible token, a non-fungible token (NFT), and/or a cryptocurrency.

The digitally signed voucher may be represented by one or more of binary data, a string, a quick-response code (QR code), a base64 encoded string, an array, an extended markup language (XML) file, and/or a JavaScript object notation (JSON) file. Those skilled in the art will now appreciate that the present method provides a superior number of formats for instantiating payments between transferor and recipient compared to the current state of the art, thereby allowing the payment method to be used in more contexts and across a wider variety of systems.

According to an alternate aspect of the present disclosure there is presented a method for processing a payment of a digital asset by a transferor to a recipient using a smart contract on a blockchain, the method comprising: instantiating a payment channel in the smart contract by the transferor; transferring the digital asset to the smart contract by the transferor; generating a digitally signed voucher for the payment by the transferor; and transferring the digitally signed voucher to the recipient by the transferor, and wherein the payment channel comprises a blockchain address of the recipient and the smart contract comprises functionality for determining a validity of the digitally signed voucher.

According to another alternate aspect of the present disclosure there is presented a method for transferring a digital asset from a transferor to a recipient using a smart contract and a digitally signed voucher, said method comprising: the recipient receiving a digitally signed voucher from the transferor; and the recipient presenting the digitally signed voucher to the smart contract, and wherein the digitally signed voucher is digitally signed by the transferor, the smart contracts comprises the digital asset, and on verifying the digitally signed voucher is valid, the smart contract transfers the digital asset to the recipient.

According to yet another alternate aspect of the present disclosure there is presented a system comprising a smart contract for enabling a payment of a digital asset by a transferor to a recipient using a digitally signed voucher, the smart contract comprising: a data structure instantiating a payment channel, said data structure comprising a first blockchain address of the transferor, a second blockchain address of the recipient, and the digital asset; and functionality for determining a validity of the digitally signed voucher, and the digitally signed voucher comprising: a digital signature of the transferor; an amount of the digital asset; and a second blockchain address of the recipient, and wherein, on receipt of the digitally signed voucher, if the smart contract determines the digitally signed voucher to be valid, the smart contract transfers the amount of the digital asset to the second blockchain address.

### BRIEF DESCRIPTION OF DRAWINGS

It is important to understand that the drawings included in this disclosure are provided solely for illustrative purposes and do not delineate the full scope of the present system. The figures are not necessarily drawn to scale; the relationships between objects in each figure may also not reflect accurate proportions. In some cases, the size, position, or other attributes of the objects may be reversed or otherwise altered to better illustrate the concept being described. The primary intention of these figures is to enhance comprehension and clarity regarding the structure of each depicted element. Consequently, certain features may be exaggerated or otherwise modified to highlight specific aspects of the structure more effectively.

Furthermore, the present system is elaborated upon in greater detail through these accompanying drawings. These illustrations are intended to demonstrate features of various illustrative embodiments, which may be combined or separated in whole or in part. Each drawing aims to provide a visual representation that supports the textual description, thereby offering a more complete understanding of the inventive concepts and their potential applications.

By way of example, the figures serve to visually explain aspects of the present system, showcasing different embodiments that highlight its versatility and adaptability. These drawings are an integral part of the disclosure, providing a means to visualize and contextualize the detailed descriptions provided herein. This approach ensures that the scope of the present system, as claimed, is fully understood, despite the illustrative nature of the figures.

FIG. 1 is a flow chart illustrating a method for securely paying an amount of a digital asset to a recipient by a transferor using a smart contract and a payment voucher.

FIG. 2 is a block diagram illustrating a data structure for storing data pertaining to a payment channel instantiated on a blockchain using a smart contract.

FIG. 3 is a block diagram illustrating a data structure for recording relevant information to a payment channel for a token or digital asset.

FIG. 4A is a block diagram illustrating a first embodiment of a mapping from a transferor to a plurality of payment channels.

FIG. 4B is a block diagram illustrating a second embodiment of a mapping from a transferor to a plurality of payment channels.

FIG. 5 is a flow chart illustrating a method for verifying a validity of a payment voucher.

FIG. 6 is a block diagram illustrating a structure of a payment voucher.

FIG. 7 is a block diagram illustrating a smart contract for a payment system.

FIG. 8 is a block diagram illustrating a data structure for storing data pertaining to a payment channel for payment using one or more non-fungible tokens (NFTs), and a data structure for recording relevant information to the payment channel for the one or more NFTs.

FIG. 9 is a block diagram illustrating a structure of a payment voucher for payment using one or more NFTs.

FIG. 10 shows an exemplary communications network that may be used to implement methods disclosed herein.

### DETAILED DESCRIPTION OF THE INVENTION

The following disclosure describes illustrative embodiments that, in conjunction with the accompanying drawings, demonstrate the aforementioned features and advantages, as well as additional benefits. The subsequent description sets forth exemplary details, such as architecture, interfaces, techniques, and attributes, for purposes of explanation rather than limitation. It will be evident to those skilled in the art that other embodiments, differing from these details, are nonetheless within the scope of the appended claims. Additionally, for clarity, detailed descriptions of well-known devices, circuits, tools, techniques, and methods are omitted to avoid obscuring the description of the present system.

The term “and/or,” and its variations, should be understood to mean that one or more of the recited elements may be present (for example, only one recited element is present, two of the recited elements may be present, and so on, up to all of the recited elements may be present) in a system according to the claims and in accordance with one or more embodiments of the present system.

Blockchains are typically immutable, that is to say, the transfer of digital assets from one entity to another cannot be reversed after the fact, which carries with it significant risks that are not encountered in conventional asset transfers. One of the primary issues is that blockchain transactions are effectively irreversible once completed. This means that if an error occurs during the transaction process, such as sending assets to the wrong address, there is no straightforward method to recover those assets. This contrasts sharply with traditional financial systems where transactions can often be reversed or corrected through established dispute resolution mechanisms.

For example, if a transferor sends an amount of a token on the Ethereum blockchain, such as USDC or USDT, to an incorrect Ethereum address or to an address that is not in active use, the transferor loses the ability to retrieve those tokens. This creates a considerable risk for both the transferor and the recipient. The recipient, who is expecting a payment, may reasonably conclude that the payment has not been made if it does not arrive at the correct address. This can lead to disputes and financial losses that are difficult to resolve without a centralised authority or intermediary to mediate the issue.

These challenges are not limited to token transfers on the Ethereum blockchain; they extend to native cryptocurrencies and most other blockchain-instituted tokens. For instance, transactions involving bitcoin on the Bitcoin blockchain or ether on the Ethereum blockchain are also subject to these irreversibility constraints. The decentralised and immutable nature of these systems, which is a fundamental feature designed to ensure security and trustlessness, ironically introduces a significant level of risk in asset transfer scenarios. As a result, users must exercise extreme caution when conducting transactions to avoid irreversible mistakes that can lead to substantial financial losses.

Certain blockchains, such as the Ethereum blockchain, allow participants to deploy decentralised software applications known as smart contracts. These blockchains and smart contracts can create independently ownable digital assets, such as tokens or cryptocurrencies, or facilitate the transfer and transformation of digital assets within the realm of decentralised finance (DeFi). Access to these smart contracts is typically provided through websites that use software libraries to interact with and retrieve data from blockchains. These websites are often referred to as part of web3 or web 3.0.

The system, device, method, arrangement, interface, computer program, artificial intelligence system, process, mechanical form, structure, linkages, and so forth, (hereinafter each of which will be referred to as system, or otherwise such as method, device, and so on, and should be understood to be interchangeable, unless the context indicates otherwise), described herein address problems in previous systems and offer advantages compared to said previous systems. Moreover, embodiments of the present system enhance the operation, efficiency, and reliability beyond those provided by the previous systems. For instance, by offering information on specific deficiencies, embodiments of the present system significantly improve efficiency over the previous systems and assist parties in addressing those deficiencies directly.

In aspects of the present disclosure, systems and methods are disclosed for providing a secure, user-friendly and error-resistant system for ensuring digital asset payments between a transferor and a recipient.

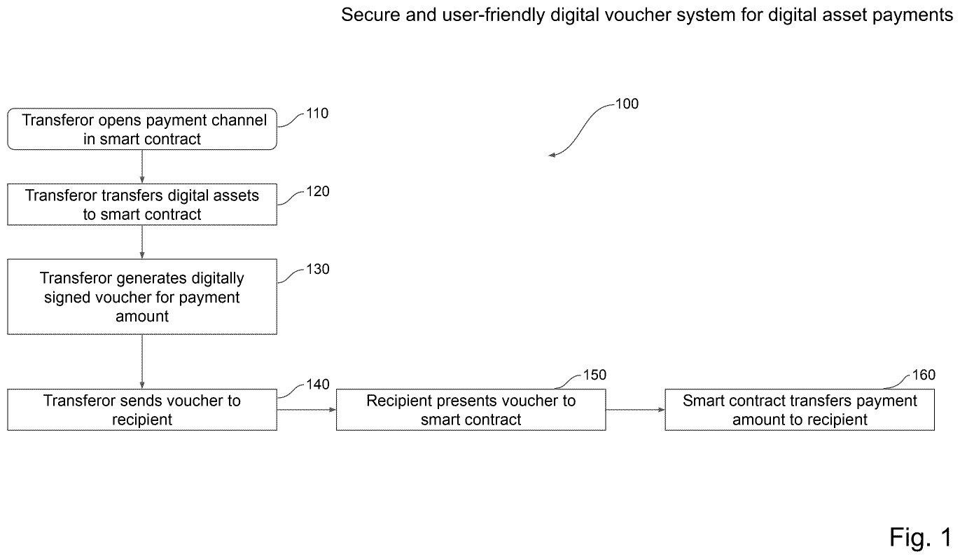

In accordance with embodiments of the present system, a method 100 for transfers of digital assets from a transferor to a recipient may be implemented using a smart contract and a payment voucher (henceforth referred to as a voucher) as illustrated in FIG. 1. Actions may start with the transferor opening a payment channel between the transferor and the recipient in a smart contract, as shown in step 110.

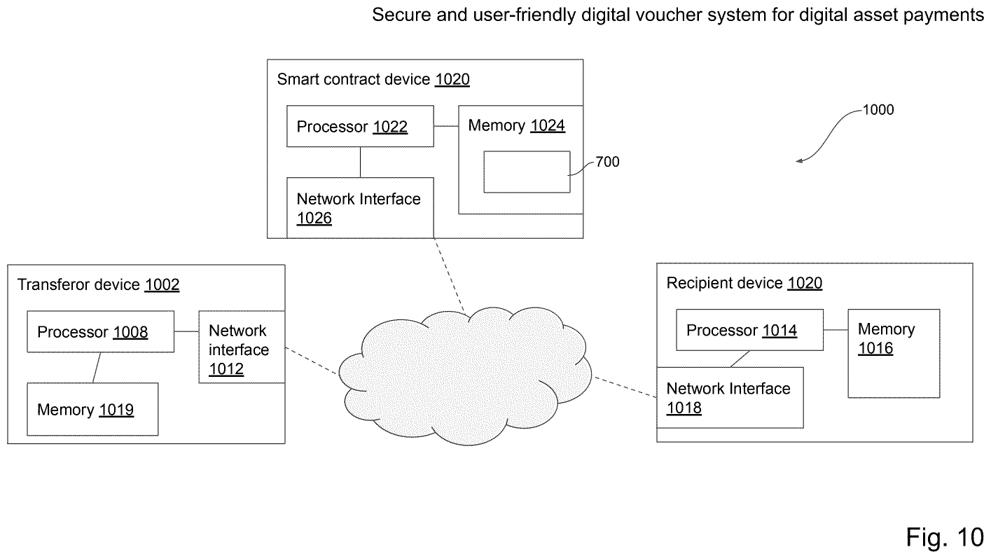

In embodiments, actions referred to herein as being performed by the transferor may be performed by a computing device associated with (for example, belonging to or operated by) the transferor, such as the transferor device 1002 described below with reference to FIG. 10. For example, at step 110, a computing device associated with the transferor (such as the device 1002) may open a payment channel to a computing device associated with the recipient (such as the recipient device 1004 described below with reference to FIG. 10). The same is true of steps 120, 130, and 140 described below, which may all be performed by a computing device associated with the transferor, such as the transferor device 1002.

Actions may then proceed to step 120, in which the transferor may transfer digital assets to the smart contract, which may be recorded against the payment channel by the smart contract as a balance of the payment channel. In some embodiments, specific digital assets may have minimum and/or maximum deposit and/or payment amounts set in the smart contract, and the smart contract may reject deposits and/or payments that fall below the minimum and/or above the maximum amounts.

Actions may then proceed to step 130, in which the transferor may generate a digitally signed voucher for paying an amount of digital assets to the recipient. The digital voucher may be signed by the transferor using a private key and a digital signature algorithm, for example but not limited to, a Rivest-Shamir-Adleman (RSA) digital signature algorithm, an Elliptic Curve Digital Signature Algorithm (ECDSA), an Edwards-curve Digital Signature Algorithm (EdDSA), a Shnorr signature algorithm, or some other digital signature algorithm.

Actions may then proceed to step 140, in which the transferor may send the digitally signed voucher to the recipient. The digitally signed voucher may be transmitted over a blockchain, or over an out-of-band communication channel, for example but not limited to, email, a messenger application, on paper or a web page through a quick-response code (QR code), a text message, or some other communication channel.

Actions may then proceed to step 150, in which the recipient may present the digitally signed voucher to the smart contract. Presentation of the voucher may occur through a transaction comprising the digitally signed voucher, said transaction calling a function of the smart contract.

In line with the above note regarding the transferor, actions referred to herein as being performed by the recipient may be performed by a computing device associated with (for example, belonging to or operated by) the recipient, such as the recipient device 1004 described below with reference to FIG. 10. For example, at step 150, a computing device associated with the recipient (such as the device 1004) may present/transmit the digitally signed voucher to a computing device executing the smart contract (such as the smart contract device 1020 described below with reference to FIG. 10).

Actions may finally proceed to step 160, in which the smart contract may transfer a payment of an amount of the digital assets specified in the digitally signed voucher to the recipient. The payment may be contingent on a set of conditions encoded in and checked by the smart contract, for example but not limited to: the payment amount being less than or equal to the balance of the payment channel, the payment amount being more than a minimum payment requirement, the digitally signed voucher comprising a valid signature of the transferor, the digitally signed voucher comprising a valid sequence number or cryptographic nonce (an arbitrary number that can be used just once in a cryptographic communication), the payment channel not having expired, and/or the digitally signed voucher comprising a valid expiry data that has not expired. Expiration of the payment channel and/or the digitally signed voucher may be expressed as a date and time, for example an ISO 8601-compliant string, or as a blockchain block height.

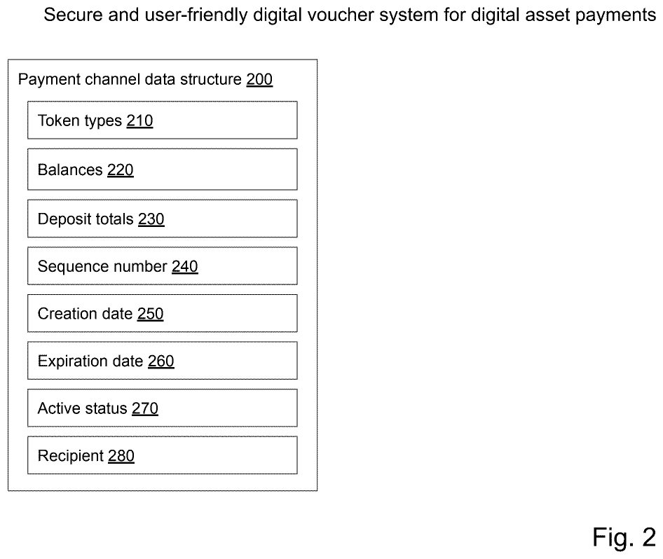

In embodiments, actions referred to herein as being performed by the smart contract may be performed by a computing device executing the smart contract (that is, executing code which implements the functionality of a smart contract), such as the smart contract device 1020 described below with reference to FIG. 10. For example, at step 160, a computing device executing the smart contract (such as the device 1020) may transfer a payment of an amount of the digital assets specified in the digitally signed voucher to a computing associated with the recipient (such as the recipient device 1004 described below with reference to FIG. 10). FIG. 2 illustratively shows a payment channel data structure 200 for implementing a payment channel, in accordance with embodiments of the present system. A payment channel may comprise data fields within a smart contract for defining and storing information concerning the payment channel. In some embodiments, the payment channel data structure 200 may comprise a list, array, mapping, or variable of one or more token types 210, specifying which token type or token types are supported by the payment channel. For example but not meant to be limiting in any way, a payment channel for a smart contract on the Ethereum blockchain may comprise an array of tokens including USDC, USDT, and ether. Each token may be specified by a smart contract address for the token, in the case of ether or other cryptocurrencies not instantiated by a smart contract by a marker (for example the zero address or a distinctive artificially generated address that is clearly not a contract deployment address for ETH), or a string of text.

The payment channel data structure 200 may comprise a list, array, mapping, or variable of balances 220. The balances may indicate what amount of each supported token type has been deposited by the transferor or some other party on behalf of the transferor. If the balances 220 are stored as a list or array, each balance may correspond to a token from the token types 210 by index.

The payment channel data structure 200 may comprise a list, array, mapping, or variable of deposit totals 230. Which may indicate a total amount of each token deposited over a lifetime of the payment channel. Those skilled in the art will now appreciate that a deposit total from the deposit totals 230 minus a corresponding balance from the balances 220 equals an amount paid out from the payment channel to the recipient in that token.

The payment channel data structure 200 may comprise a sequence number 240 used to track which digitally signed voucher may be redeemed. Digitally signed vouchers may be required to include a sequence number, and may only be redeemable in sequence. The sequence number 240 may thus start at a value of 1 and be incremented each time an appropriate digitally signed voucher is redeemed for tokens. In some embodiments the sequence number 240 may comprise an array or list, with each element corresponding to a token in the token types 210 array or list.

The payment channel data structure 200 may comprise a creation date 250 and/or an expiration date 260. The creation date may record when the payment channel became active, and in some embodiments may be a time and date in the future, thus establishing a payment channel that becomes active at a later date and time. The expiration date 260 may record a date and time after which digitally signed vouchers may not be redeemed, thus providing an end time for the payment channel, before which the transferor may not extract deposits from the payment channel, and after which the transferor may extract deposits from the payment channel.

The payment channel data structure 200 may comprise an active status 270 flag, Boolean, or variable indicating whether the payment channel is available for use. In some embodiments the active status 270 may be determined programmatically from the creation date 250 and the expiration date 260.

The payment channel data structure 200 may comprise a recipient 280, indicating a valid recipient for assets redeemed by the digitally signed voucher. The recipient 280 may be a blockchain address, for example but not limited to, an Ethereum address. In some embodiments, deposits in the payment channel may only be redeemed by the recipient 280 specified.

Those skilled in the art will now appreciate that not all data structure entries may be required, and that some entries, for example but not limited to the recipient 280 and the active status 270 may be deduced or stored elsewhere in the smart contract data structures.

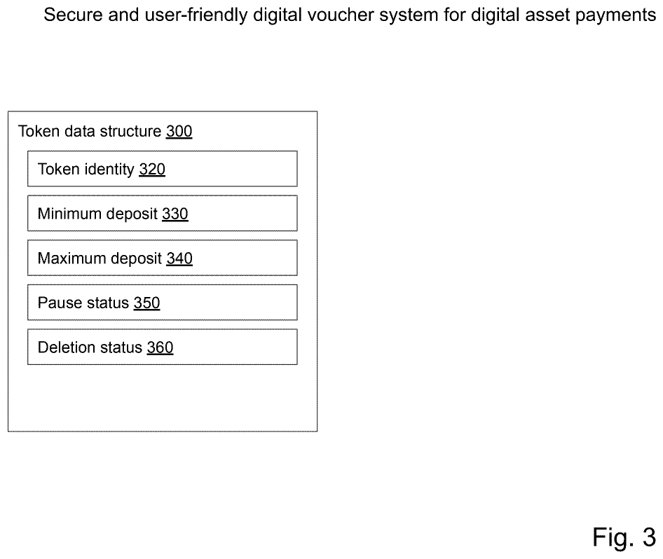

In accordance with embodiments of the present system, as illustrated in FIG. 3, the token types 210 of FIG. 2 may be specified using a collection of one or more token data structures 300. A token data structure 300 may comprise one or more of a token identity 320, a minimum deposit 330, a maximum deposit 340, a pause status 350, and a deletion status 360. The token identity 320 may specify which token is represented through, for example, a smart contract address for the smart contract instantiating the token, or a string containing a unique or known identifier for the token. The minimum deposit 330 may specify a minimum amount of the token that must be deposited when instantiating a payment channel comprising the token. The maximum deposit 340 may specify a maximum amount of the token that a payment channel comprising the token may hold. The pause status 350 may comprise a Boolean or other variable indicating whether the token specified by the token identity 320 may currently be used for transactions. The smart contract may check the pause status 350 before deciding to permit or prevent a transaction of the token. For example, if the pause status 350 is set, transactions such as depositing an amount of the token in the smart contract, or redeeming a digitally signed voucher for an amount of the token may fail. The deletion status 360 may comprise a Boolean or other variable indicating whether the token specified by the token identity 320 is no longer in use by the smart contract. Those skilled in the art will now appreciate that the deletion status 360 may function like a permanent pause status 350. In some embodiments of the present system, digitally signed vouchers may still be redeemable after the pause status 350 and/or the deletion status 360 are set to “true”, but deposits of further amounts of the token into a payment channel may be prevented.

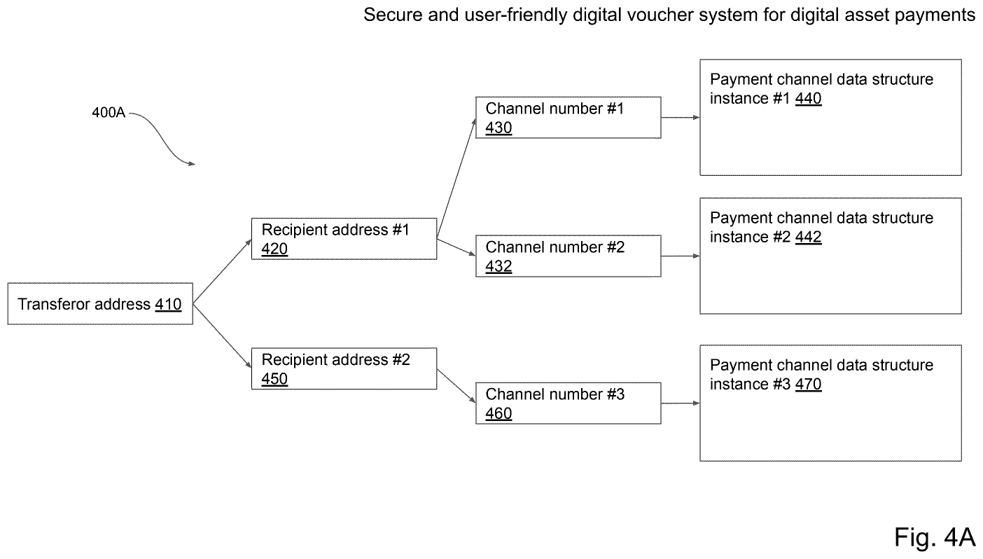

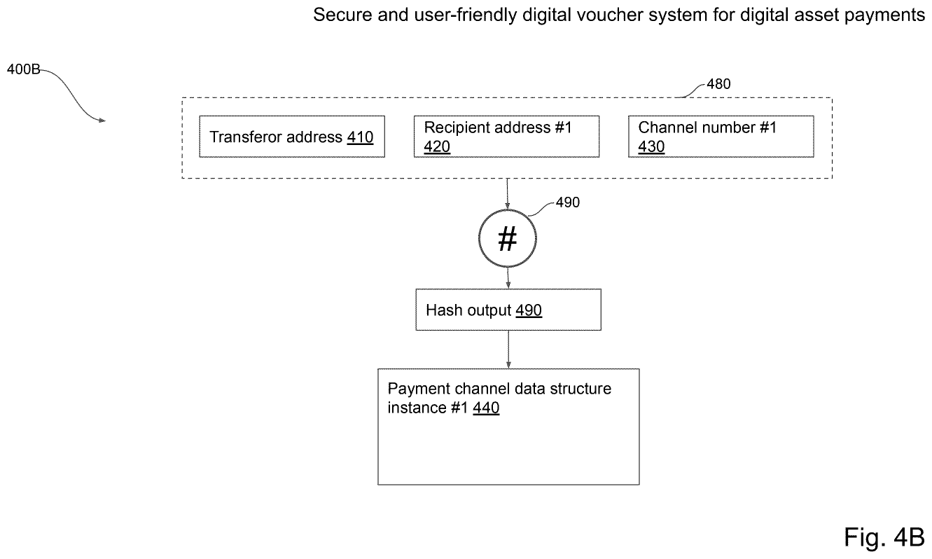

In accordance with some embodiments of the present system, a mapping may be used to map transferor addresses through recipient addresses to payment channel data structure instances, as illustrated in FIG. 4A and FIG. 4B. In the smart contract programming language Solidity, which is used to write smart contracts for the Ethereum blockchain and other Ethereum-compatible blockchains, a mapping is a key/value store that allows values to be associated with unique keys. Keys may themselves be mappings.

In FIG. 4A a method for a mapping of mappings 400A is presented, which may map a transferor address 410 to a mapping of recipient addresses that map to channel numbers, which then map to payment channel data structure instances. For example, presented for illustrative purposes and not meant to be limiting, the transferor address 410 may map to a mapping of a first recipient address 420 and a second recipient address 450. The first recipient address 420 may then map to a mapping of channel numbers, for example a first channel 430 and a second channel 432. The first channel may map to a first payment channel data structure instance 440, and the second channel 432 may map to a second payment channel data structure instance 442. The second recipient address 450 may map to a third channel number 460, which may map to a third payment channel data structure instance 470. Generalizing, any given transferor address may map to one or more recipient addresses, which may map to one or more channels, with each channel mapping to a payment channel data structure instance. Through this mapping of mappings 400 the smart contract may track one or more payment channels from a transferor to one or more recipients. In some embodiments, the mapping of mappings 400 may be considered part of the payment channel data structure previously disclosed in FIG. 2.

In FIG. 4B a method for a mapping 400B is presented. A specific example is presented for illustrative purposes only that is not meant to be limiting in any way. The transferor address 410, recipient address #1 420, and channel number #1 430 may be concatenated to form a concatenation 480 and said concatenation 480 may be provided as an input to a cryptographic hash function 490, producing a hash output 490. The hash output 490 may then be mapped to the payment channel data structure instance #1 440. Those skilled in the art will now appreciate in light of the example that in general any transfer address, recipient address, and channel number may thus be uniquely mapped to a payment channel data structure instance, provided the cryptographic hash function chosen is collision resistant.

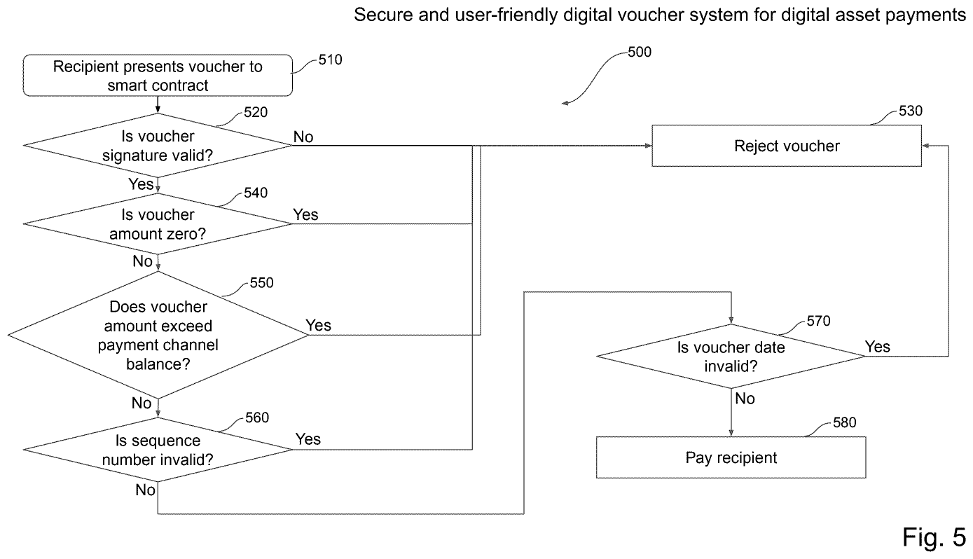

In FIG. 5, a flow chart 500 illustrating a method for paying a recipient an amount of a token or cryptocurrency on presentation of a valid digitally signed voucher is presented, in accordance with some embodiments of the present system.

Actions may commence with a recipient presenting a voucher to a smart contract, as shown in step 510. The voucher may, in some embodiments, be presented via a blockchain transaction sent by the recipient to the blockchain, said blockchain transaction comprising the voucher and a function call to the smart contract.

Actions may then proceed to step 520, in which the smart contract may determine whether the voucher is signed with a valid digital signature. If the voucher does not comprise a valid digital signature, actions may proceed to step 530, the voucher may be rejected by the smart contract, and no payment may be made to the recipient presenting the voucher. If the voucher does comprise a valid digital signature, actions may proceed to step 540. In some embodiments, a valid digital signature may consist of binary data comprising a digital signature of an output of a cryptographic hash function applied to part of the voucher, said digital signature generated with a private key of a public/private key pair, where the public key derived from the private key may be used to derive an identifier of the transferor, for example, a blockchain address.

In some embodiments, the transferor and/or the recipient may be alerted (that is, notified) at step 530 when the voucher is found invalid and rejected. For example, the smart contract (or a device executing the smart contract, such as the smart contract device 1020 described below with reference to FIG. 10) may transmit a notification to the transferor (or a device associated with the transferor, such as the transferor device 1002 described below with reference to FIG. 10) indicating that validation of the voucher was not successful. Additionally or alternatively, the smart contract (or a device executing the smart contract, such as the smart contract device 1020 described below with reference to FIG. 10) may transmit a notification to the recipient (or a device associated with the recipient, such as the recipient device 1004 described below with reference to FIG. 10) indicating that validation of the voucher was not successful.

In step 540, the smart contract may determine whether an amount of a digital asset for payment specified in the voucher is zero. If the amount is determined to be zero, actions may proceed to step 530, the voucher may be rejected by the smart contract, and no payment may be made to the recipient presenting the voucher. If the amount is determined to be a positive number, actions may proceed to step 550.

In step 550, the smart contract may determine whether the amount of the digital asset for payment specified in the voucher exceeds a current balance of a payment channel between the transferor and the recipient. If the amount exceeds the current balance, actions may proceed to step 530, the voucher may be rejected by the smart contract, and no payment may be made to the recipient presenting the voucher. If the amount is determined to be less than or equal to the current balance, actions may proceed to step 560.

In step 560, the smart contract may determine whether the voucher comprises a valid sequence number. If the voucher does not comprise a valid sequence number, actions may proceed to step 530, the voucher may be rejected by the smart contract, and no payment may be made to the recipient presenting the voucher. If the voucher does comprise a valid sequence number, actions may proceed to step 570. A sequence number may be used to prevent vouchers from being used twice. In some embodiments, the smart contract may track a current sequence number, and once a voucher with the current sequence number is presented and redeemed, the current sequence number may be incremented. The smart contract may thus reject any voucher presented that does not comprise the current sequence number. In other embodiments, valid sequence numbers may be recorded in a data structure, for example, an array, a list, or a mapping, and once a valid sequence number is used, the valid sequence number may be marked as invalid in the data structure and may not be used again.

In step 570, the smart contract may determine whether the voucher comprises a valid date. If the voucher does not comprise a valid date, actions may proceed to step 530, the voucher may be rejected by the smart contract, and no payment may be made to the recipient presenting the voucher. If the voucher does comprise a valid date, actions may proceed to step 580, in which the smart contract may pay the recipient the amount specified in voucher, for example, by transferring the amount in digital assets to the recipient blockchain address. A date may be determined to be valid if one or more of the following apply: the data falls between the creation date and the expiry date of the payment channel, and/or the date is not in the future.

In some embodiments, the transferor and/or the recipient may be alerted (that is, notified) at step 580 when the voucher is found valid and payment is made. For example, the smart contract (or a device executing the smart contract, such as the smart contract device 1020 described below with reference to FIG. 10) may transmit a notification to the transferor (or a device associated with the transferor, such as the transferor device 1002 described below with reference to FIG. 10) indicating that validation of the voucher has been successful. Additionally or alternatively, the smart contract (or a device executing the smart contract, such as the smart contract device 1020 described below with reference to FIG. 10) may transmit a notification to the recipient (or a device associated with the recipient, such as the recipient device 1004 described below with reference to FIG. 10) indicating that validation of the voucher has been successful.

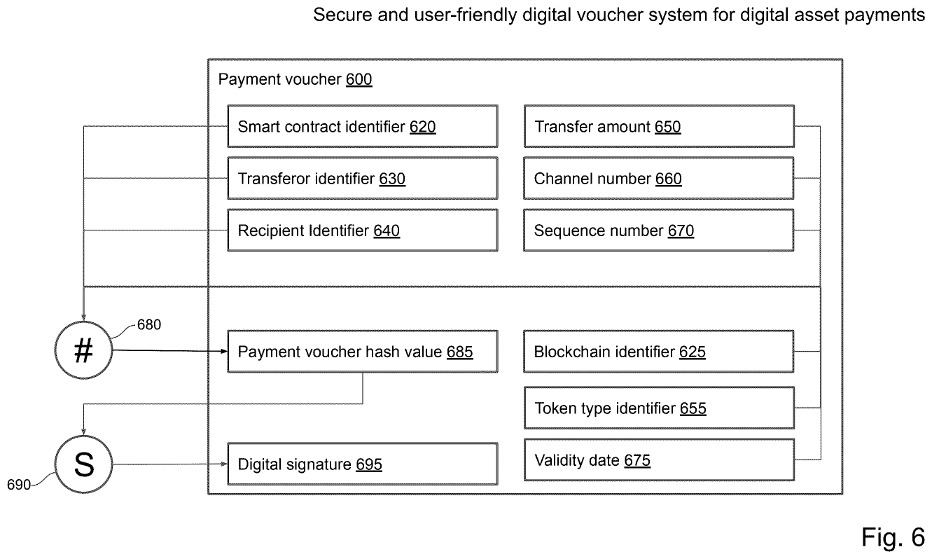

In FIG. 6, a block diagram illustrating a possible implementation of a payment voucher 600 is presented, in accordance with some embodiments of the present system. The payment voucher 600 may comprise digital data structured in a defined manner, and may be presented to the recipient as binary data, a string, a quick-response code (QR code), a base64 encoded string, an extended markup language (XML) file, a JavaScript object notation (JSON) file, or some other representation of the payment voucher 600.

The payment voucher 600 may comprise a smart contract identifier 620 identifying which smart contract is used for instantiating the payment channel, and for differentiating between different instances of the same smart contract or similar smart contracts. In some embodiments, the smart contract identifier 620 may be a blockchain address for the smart contract. The recipient may use the smart contract identifier to construct an appropriate transaction directed at the correct smart contract to redeem the payment voucher.

The payment voucher 600 may comprise a blockchain identifier 625, which may be a unique number identifying which blockchain the smart contract was deployed on. For example, if the same deployment account is used on a plurality of Ethereum-compatible blockchains such as Ethereum, Polygon, and Binance Smart Chain to deploy the same smart contract, each smart contract may have the same contract address, and the same payment voucher may be redeemable on each chain. The blockchain identifier 625 ensures that each payment voucher may only be used on one specific chain.

The payment voucher 600 may comprise a transferor identifier 630 for identifying the transferor. The transferor identifier 630 may comprise a public key or a blockchain address derived from the public key, and may be used by the smart contract to verify a digital signature 695.

The payment voucher 600 may comprise a recipient identifier 640, which, in some embodiments, may comprise a public key of the recipient, or a blockchain address derived from the public key of the recipient. The recipient identifier 640 may be used by the smart contract to verify that a transaction redeeming the payment voucher was sent by a party matching the recipient for whom the payment voucher was intended.

The payment voucher 600 may comprise a transfer amount 650 specifying an amount of a digital asset to transfer to the recipient. The payment voucher 600 may also comprise a token type identifier 655 specifying what asset the digital asset is. In some embodiments, the token type identifier 655 may be an address of a smart contract instantiating the digital asset.

The payment voucher 600 may comprise a channel number 660. Channel numbers were previously defined in FIG. 4 and may provide for multiple payment channels between the same transferor and recipient through a mapping from the transferor identifier to the recipient identifier to the channel number 600.

The payment voucher 600 may comprise a sequence number 670. In some embodiments, a payment voucher with a sequence number N may only be redeemed after prior payment vouchers with sequence numbers 1, 2, ..., N-1 have been redeemed. Note that prior does not necessarily imply earlier in time, in that a payment voucher with a sequence number of K may be issued at a time after a payment voucher with a sequence number of K+1, but nevertheless the payment voucher with the sequence number of K may be required to be redeemed before the payment voucher with the sequence number of K+1. In other embodiments, after redemption of a payment voucher with sequence number N the smart contract may mark sequence number N as used, and thus may reject subsequent payment vouchers with the same sequence number N, thus preventing double-spending of a given payment voucher.

The payment voucher 600 may comprise a validity date 675, which may be a string comprising a date and time in ISO 8601 format, a Unix timestamp, a blockchain block height, or some other time and date specification. In some embodiments the payment voucher 600 may not be redeemable before the validity date 675, whereas in other embodiments the payment voucher 600 may not be redeemable until after the validity date 675.

The payment voucher 600 may comprise a payment voucher hash value 685, which in some embodiments may be calculated by applying a cryptographic hash function 680 to one or more of the payment voucher 600 components, including the smart contract identifier 620, the blockchain identifier 625, the transferor identifier 630, the recipient identifier 640, the transfer amount 650, the token type identifier 655, the channel number 660, the sequence number 670, and/or the validity date 675. In some embodiments the cryptographic hash function 680 may be applied to a concatenation of the payment voucher 600 components. In some embodiments the payment voucher 600 may not comprise the payment voucher hash value 685, and the payment voucher hash value 685 may be calculated independently by the smart contract from the payment voucher 600 components.

The payment voucher 600 may comprise a digital signature 695. The digital signature 695 may be generated by applying a digital signature algorithm 690 to the payment voucher hash value 685 using a private key of a public/private key pair. In some embodiments, the transferor may own the private key, and the transferor identifier 630 may be derived from the private key and/or the public key.

In some embodiments of the present system, the transferor may generate and sign a voucher not specifying a particular recipient in the voucher, and the smart contract may be configured to allow the voucher to be redeemed by anyone, forming an equivalent of a “blank check”. To avoid front-running transactions, the smart contract may first require a cryptographic hash function digest of the voucher to be presented before presentation and redemption of the voucher in a commit-reveal transaction pair.

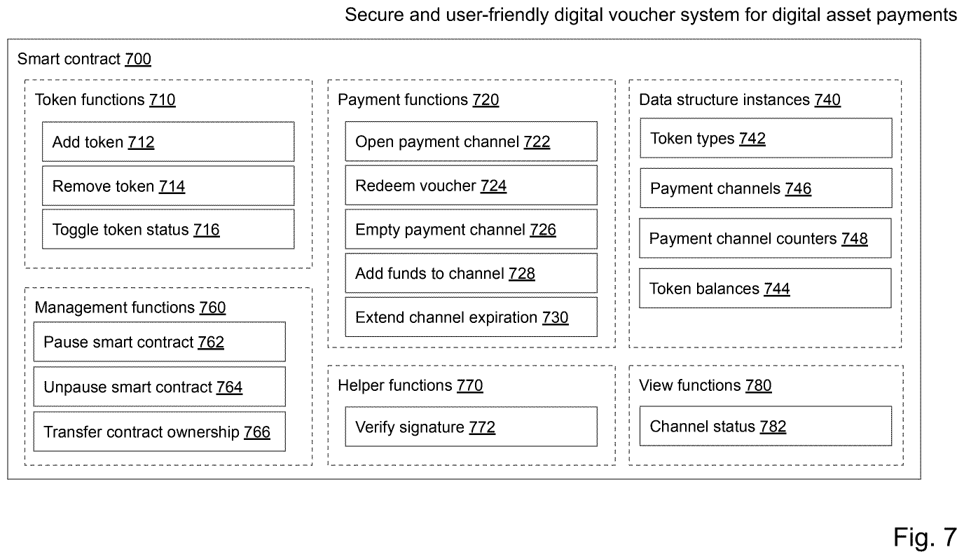

In FIG. 7, a block diagram illustrating a possible implementation of a smart contract 700 in accordance with some embodiments of the present system is presented. Functions of the smart contract 700 are grouped according to functionality types for clarity.

The smart contract 700 may comprise token functions 710 for registering and/or deregistering details pertaining to supported token types in the contract. The token functions may comprise an add token function 712 for adding a token to the supported tokens list, a remove token function 714 for removing a token from the supported tokens list, and a toggle token status function 716 for temporarily pausing actions related to a specific token type. In some embodiments of the present system, the token functions 710 may instantiate, modify, or delete instances of the token data structure 300 disclosed in FIG. 3. In some embodiments, use of the token functions 710 may be restricted to a subset of blockchain users, for example but not limited to, only an owner of the smart contract 700 or a defined set of smart contract 700 administrators.

The smart contract 700 may comprise management functions 760 relating to the status and ownership of the smart contract 700. The smart contract may comprise a pause smart contract 762 function, which when called may suspend some or all of the smart contract functions, or may restrict deposits and withdrawals of tokens from the smart contract. The smart contract may comprise an unpause smart contract 764 function, which may remove restrictions imposed on the smart contract 700 functionality by the pause smart contract 762 function. The smart contract 700 may comprise a transfer contract ownership 766 function, which may transfer ownership of the smart contract 700 from a initial owner to a new owner, and which, in some embodiments, may restrict the initial owner from successfully calling restricted functions in the smart contract 700, and may grant the new owner the capability of successfully calling the restricted functions. In some embodiments, use of the management functions 710 may be restricted to a subset of blockchain users, for example but not limited to, only an owner of the smart contract 700 or a defined set of smart contract 700 administrators.

The smart contract 700 may comprise helper functions 770 for performing computations, calculations, and/or verifications. In some embodiments the helper functions 770 may be internal to the smart contract 700 and therefore not callable from outside the smart contract. The helper functions 770 may comprise a verify signature 772 function that can verify whether a payment voucher comprises a valid digital signature.

The smart contract may comprise view functions 780 for querying the smart contract 700 to determine an internal state of the smart contract 700. The view functions 780 may comprise a channel balance 782 function, wherein a call to the channel balance 782 function with parameters that may include one or more of: a transferor identifier, a recipient identifier, and a channel number may return a status of a corresponding payment channel, which may comprise one or more of: a balance for each token held in the payment channel, an expiry data for the payment channel, a creation date for the payment channel, a current sequence number for the payment channel, an active status for the payment channel, a list of token types supported, a list of deposit totals for each token over the lifetime of the payment channel.

The smart contract may comprise data structure instances 740 storing data relating to payment channels and token types supported. The data structure instances 740 may comprise token types 742, which may comprise instances of token data structures 300 as disclosed in FIG. 3. The data structure instances 740 may comprise payment channels 746, which may comprise instances of payment channel data structures 200 as disclosed in FIG. 2. The data structure instances 740 may comprise payment channel counters 748, which may comprise instances of channel number mappings as disclosed in FIG. 4. The data structure instances 740 may comprise token balances, which may record balances of different digital assets within each payment channel instance.

The smart contract may comprise payment functions 720 for handling transactions related to payments. The payment functions 720 may comprise an open payment channel 722 function, which may enable a transferor to instantiate a new payment channel between the transferor and a recipient in a token or tokens specified by parameters supplied to the open payment channel 722 function when opening the payment channel. The open payment channel 722 function may instantiate an appropriate payment channel data structure instance as disclosed in FIG. 2, and may configure an appropriate mapping entry as disclosed in FIG. 4.

The payment functions 720 may comprise a redeem voucher 724 function, which may be called by a recipient with a payment voucher as a parameter supplied to the redeem voucher 724 function to redeem tokens held by the smart contract 700 and registered against a payment channel specified in the corresponding payment channel. The redeem voucher 724 function may, in some embodiments of the present system, implement functionality disclosed in FIG. 5.

The payment functions 720 may comprise an empty payment channel 726 function that may enable a transferor to withdraw tokens registered against a payment channel from the smart contract 700. In some embodiments, the empty payment channel 726 may only execute successfully if the payment channel has expired (as indicated by the present time being at or after the payment channel expiry date) and/or if the active status of the payment channel is marked as inactive. In other embodiments, by prior agreement between the recipient and the transferor the channel may be made to expire earlier than specified by the payment channel expiry date, for example but not limited to: through a channel closing voucher signed by the recipient and presented to the smart contract by the transferor or the recipient, through a payment voucher specifying a payment of zero tokens issued by the transferor and presented to the smart contract by the recipient, and/or through a function (not shown) called by the recipient and optionally by the transferor to explicitly close the channel.

The payment functions 720 may comprise an add fund to channel 728 function that may enable a transferor to add further amounts of a token to a non-expired payment channel. In some embodiments, only the transferor may be allowed to add further amounts of a token to the non-expired payment channel, whereas in other embodiments other parties may be allowed to add further amounts.

The payment functions 720 may comprise an extend channel expiration 730 function that may enable a transferor to extend the expiry date of a payment channel. In some embodiments, a payment channel may have a predetermined limit as to how far into the future the payment channel's expiry date may be extended.

In some embodiments of the present system, a smart contract instantiating the payment system may have an implicit token type hard-coded into the smart contract code, obviating the need for the token data structure 300, and the token type identifiers in the payment channel data structure 200 and the payment voucher 600.

In some embodiments of the present system, the payment system may handle non-fungible tokens (NFTs) instead of or as well as fungible tokens such as USDC, USDT, or fungible cryptocurrencies such as ether and bitcoin. An NFT is typically identified by a smart contract address of a smart contract instantiating one or more NFTs, and an index for the NFT. By modifying the system described above payments may be made using NFTs instead of fungible tokens or cryptocurrency.

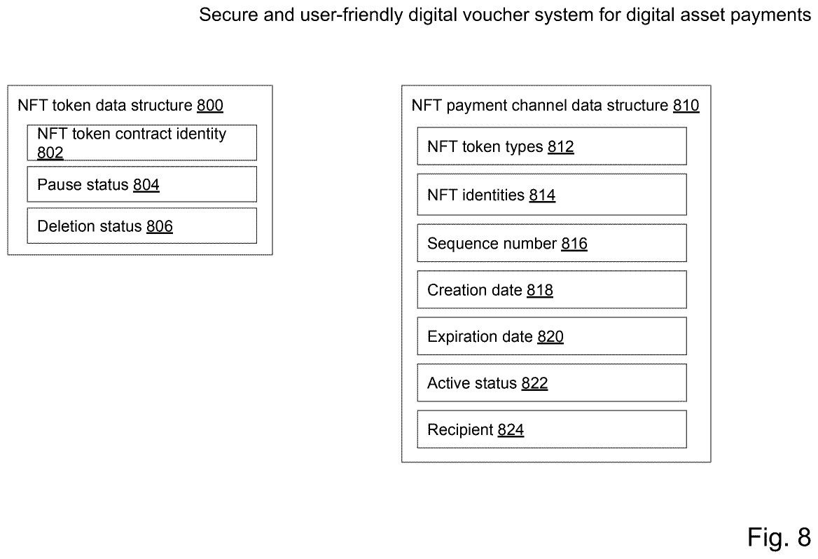

In FIG. 8, block diagrams of an NFT token data structure 800 and an NFT payment channel data structure 810 are presented.

Information pertaining to supported NFTs may be stored in the smart contract using the NFT token data structure 800, which may comprise an NFT token contract identity 802. The NFT token contract identity 802 may comprise a blockchain address at which the NFT token contract is deployed. The NFT token data structure 800 may also comprise a pause status 804 corresponding in functionality to the pause status 350 of FIG. 3, and a deletion status 806 corresponding in functionality to the deletion status 360 of FIG. 3, as previously disclosed.

An NFT payment channel may be instantiated using the NFT payment channel data structure 810. The NFT payment channel data structure 810 may comprise a list of one or more NFT token types 812, with each element of the list comprising an instance of or reference to an instance of an NFT token data structure 800. NFTs held in custody by the smart contract may be recorded and identified using NFT identities 814, which in some embodiments may comprise an array for which each element of the array is an array of numbers. The index of each element in the array may correspond to an NFT token type recorded at the same index in the NFT token types 812, and the array of numbers may record ownership of each NFT instantiated by the NFT token type, with each element of the array of numbers corresponding to an index of an NFT owned by the smart contract and recorded against the payment channel.

The NFT payment channel data structure 810 may comprise one or more of a sequence number 816 corresponding in functionality to the sequence number 240, a creation date 818 corresponding in functionality to the creation date 250, an expiration date 820 corresponding in functionality to the expiration date 260, an active status 822 corresponding in functionality to the active status 270, and/or a recipient 824 corresponding in functionality to the recipient 280, as disclosed in FIG. 2 above.

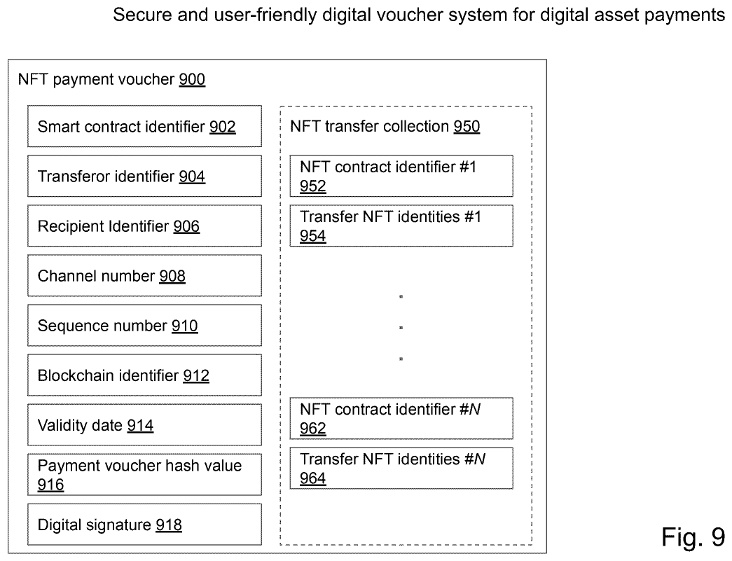

In FIG. 9, a block diagram illustrating a possible implementation of an NFT payment voucher 900 for providing payment using NFTs is presented, in accordance with some embodiments of the present system. The NFT payment voucher 900 may comprise digital data structured in a defined manner, and may be presented to the recipient as binary data, a string, a quick response code (QR code), an array, a base64 encoded string, an extended markup language (XML) file, a JavaScript object notation (JSON) file, or some other representation of the payment voucher 900.

The NFT payment voucher 900 may comprise one or more of: a smart contract identifier 902 corresponding in functionality to the smart contract identifier 620, a transferor identifier 904 corresponding in functionality to the transferor identifier 630, a recipient identifier 906 corresponding in functionality to the recipient identifier 640, a channel number 908 corresponding in functionality to the channel number 660, a sequence number 910 corresponding in functionality to the sequence number 670, a blockchain identifier 912 corresponding in functionality to the blockchain identifier 625, a validity data corresponding in functionality to the validity date 675, a payment voucher hash value 916 corresponding in functionality to the payment voucher hash value 685 and a digital signature 918 corresponding in functionality to the digital signature 695, as previously disclosed in FIG. 6.

The NFT payment voucher 900 may comprise an NFT transfer collection 950, specifying a set of NFTs that are to be transferred from the smart contract to the recipient on presentation of the NFT payment voucher 900 to the smart contract. In a possible embodiment, the NFT transfer collection 950 may specify which NFTs are to be transferred using a list of NFT contract addresses and an array of NFT indexes within the NFT contracts. For example, provided for illustrative purposes only and not meant to be limiting in any way, the transferor may be transferring NFTs from a total of N NFT smart contracts. The NFT transfer collection 950 may thus comprise a first NFT contract identifier #1 952 through to an Nth NFT contract identifier #N 962. In some embodiments, the first NFT contract identifier #1 952 may comprise a contract address of a first NFT contract, through to the Nth NFT contract identifier #N 962 comprising a contract address of an Nth NFT contract. A first transfer NFT identities #1 954 may comprise an array of NFT indexes specifying which NFTs within the first NFT contract, through to an Nth transfer NFT identities #N 964 that may comprise an array of NFT indexes specifying which NFTs within the Nth NFT contract are to be transferred to the recipient.

In some embodiments of the present system a payment channel may only allow payment for one NFT token type, in which case the NFT token types 812 may comprise a single contract address for a smart contract instantiating the NFTs, and the NFT identities 814 may comprise an array of NFT indexes. Those skilled in the art will appreciate that this is functionally equivalent to an implementation in which the NFT token types 812 is an array with only one element (a token contract address), and the NFT identities is an array with only one element, namely the array of NFT indexes.

Those skilled in the art will now appreciate in light of the above disclosures that a payment system may comprise both fungible token and non-fungible token payment through a combination of the various components disclosed.

In some embodiments of the present system, the transferor may not directly transfer digital assets such as fungible tokens or NFTs to the smart contract. Instead, the transferor may approve a transfer of the digital assets by the smart contract, and may then call a function in the smart contract triggering a transfer by the smart contract of the digital assets to the smart contract. The smart contract may then, on successful transference of the digital assets, record ownership of the digital assets by the smart contract against an instance of a payment channel as instantiated and specified by the transferor, in appropriate data fields of the payment channel instance, for example for fungible tokens in the token types 210 field and the balances 220 field as disclosed in FIG. 2, and for non-fungible tokens in the NFT token types 812 field and the NFT identities 814 field as disclosed in FIG. 8.

In some embodiments of the present system, the transferor may never transfer digital assets such as fungible tokens or NFTs to the smart contract. Instead, the transferor may provide an approval of a transfer of the digital assets by the smart contract. On presenting the payment voucher by the recipient to the smart contract, the smart contract may then use the approval to transfer the digital assets from the transferor to the recipient.

The present invention may be implemented in various computing environments. The system may be embodied in hardware, software, or a combination of both. In a typical hardware configuration, the invention can be implemented using a general-purpose computer or any other specialized computing device. This general-purpose computer may include, but is not limited to, a central processing unit (CPU), a graphics processing unit (GPU), a network interface, input/output (I/O) interfaces, memory, storage devices, and peripheral devices.

FIG. 10 shows an example communications network 1000 that may be used to implement methods disclosed herein. The network 1000 comprises a transferor device 1002, a recipient device 1004, and a smart contract device 1020, interacting via a network 1006.

The transferor device comprises a processor 1008 connected to a memory 1010 and a network interface 1012. The network interface 1012 may, for example, be configured to enable the processor 1008 to communicate via the network 1006.

Similarly, the recipient device 1004 comprises a processor 1014, a memory 1016, and a network interface 1018, and the smart contract device 1020 comprises a processor 1022, a memory 1024, and a network interface 1026; in each case the respective processor 1022, 1014 is coupled to the respective memory 1024, 1016 and the respective network interface 1026, 1018 as in the transferor device 1002.

The memory 1024 of the smart contract device 1020 may store the smart contract 700 described above. Additionally or alternatively, smart contract 700 may be stored in memory outside but accessible to the smart contract device 1020.

While FIG. 10 shows three separate devices 1002, 1004, 1020, in embodiments one or more of these devices may not be present. For example, the smart contract 700 may be stored in the memory 1016 of the recipient device 1004 and the smart contract device 1020 may not be present. Alternatively, the smart contract 700 may be stored in the memory 1010 of the transferor device 1002 and the smart contract device 1020 may not be present.

A typical computing device suitable 1002, 1004, 1020 for implementing the invention includes one or more processors, such as a CPU, that execute instructions stored in a memory.

The memory may include volatile and non-volatile memory types, such as RAM, ROM, EEPROM, flash memory, or other suitable memory technologies. The device may also comprise one or more storage devices, such as hard drives, solid-state drives, or other persistent storage mediums, which store data and executable instructions for the software implementation of the invention.

The computing device 1002, 1004, 1020 may further include various input and output interfaces, such as a keyboard, mouse, touchscreen, or other input devices for user interaction. Output interfaces may include display devices like monitors or screens, printers, or other output peripherals. Network interfaces may be incorporated to enable the device to connect and communicate over wired or wireless networks, facilitating data exchange and remote operations.

In addition to the primary hardware components, the computing device 1002, 1004, 1020 may include various peripheral devices that enhance functionality, such as cameras, sensors, additional storage devices, and specialized hardware components. Communication between the different components of the system, including peripheral devices, is typically managed via buses or other communication protocols, ensuring seamless operation and integration.

Some embodiments of the present system may be implemented as software that may be executed within an operating system environment, which manages the hardware resources and provides services for the execution of applications. The software may be developed using various programming languages and may run as standalone applications, web-based applications, or as part of a distributed system. The software modules may interact with the hardware components through system calls, function calls, APIs, and other interfaces provided by the operating system and hardware drivers.

The described hardware configuration is illustrative and not restrictive. The system can be implemented on a wide range of hardware platforms, from small embedded systems to large-scale distributed computing environments. Each embodiment may involve different combinations of hardware and software components, tailored to meet specific requirements and operational contexts.

Although the present system has been described with a limited number of embodiments, it should be understood that modifications can be made without departing from the scope of the original claimed system. All content in the foregoing specification and drawings is intended to be illustrative rather than exclusive. The discussion here is meant to exemplify the present system and should not be interpreted as restricting the appended claims to any specific embodiment or group of embodiments. Therefore, even though the present system has been discussed with reference to exemplary embodiments, it should be recognized that numerous modifications, combinations, sub-combinations, and alternative embodiments may be conceived by those skilled in the art without departing from the broader spirit and intended scope of the present system as outlined in the claims. Furthermore, any section headings included are for convenience and do not limit the scope of the present system. Consequently, the specification and drawings should be regarded as illustrative and not as limitations on the scope of the appended claims.

When interpreting the specification and appended claims, it should be understood that the term “including” does not exclude the presence of other elements or actions beyond those listed in a given description or claim. The use of “a” or “an” before an element does not exclude the presence of multiple such elements. Multiple “means” may be represented by the same item or by hardware or software implemented structure or function. Any disclosed elements may include hardware components (for example, discrete and integrated electronic circuitry and/or analog circuitry), software components (for example, computer programs and/or instructions), and/or any combination thereof. Hardware components may include both analog and digital portions. Disclosed devices or portions thereof can be combined or separated into further portions unless specifically stated otherwise. No specific sequence of acts or steps is required unless explicitly indicated. The term “plurality of” an element includes two or more of the claimed elements and does not imply any specific range; it can be as few as two elements or an immeasurable number of elements. The term “and/or” and its variations should be understood to mean that one or more of the listed elements may need to be present in the system in accordance with the description and/or claim recitation and one or more embodiments of the present system.

1. A method of processing a payment of a digital asset from a transferor to a recipient by a smart contract using a digitally signed voucher, the method comprising:
instantiating a payment channel between the transferor and the recipient;
transferring the digital asset to the smart contract;
adding a record of the digital asset against the payment channel;
generating a digitally signed voucher for the payment;
transferring the digitally signed voucher to the recipient; and
presenting the digitally signed voucher to the smart contract,
and wherein on determining that the digitally signed voucher presented is valid, the smart contract transfers the digital asset to the recipient and removes the record of the digital asset from the payment channel.

2. The method of claim 1, wherein the digitally signed voucher comprises a sequence number, the smart contract comprises a current sequence number, and the smart contract determines that the digitally signed voucher is invalid if the sequence number is not equal to the current sequence number.

3. The method of claim 2, wherein the current sequence number is incremented after the smart contract determines that the digitally signed voucher presented is valid.

4. The method of claim 1, wherein the digitally signed voucher comprises a validity date and time, and the smart contract determines that the digitally signed voucher is invalid if the validity date and time is one of: before a current date and time, after a current date and time.

5. The method of claim 1, wherein the payment channel comprises an expiration date and time, and the smart contract determines that the digitally signed voucher is invalid if the digitally signed voucher is presented after the expiration date and time.

6. The method of claim 1, wherein the digitally signed voucher comprises a digital signature of a portion of the digital voucher, said digital signature generated by the transferor, and the smart contract determines that the digitally signed voucher is invalid if the digital signature is invalid.

7. The method of claim 1, wherein the digitally signed voucher comprises a numerical amount of the digital asset, and the smart contract determines that the digitally signed voucher is invalid if a balance of the digital asset recorded against the payment channel is less than the numerical amount.

8. The method of claim 1, wherein the transferor is identified by a first blockchain address, and the recipient is identified by a second blockchain address.

9. The method of claim 1, wherein the digital asset is one or more of: an amount of a fungible token, one or more non-fungible tokens, and/or a cryptocurrency.

10. The method of claim 1, wherein the payment channel comprises: a mapping from the transferor, the recipient, and a channel number to a payment channel data structure instance.

11. The method of claim 10, wherein the payment channel data structure instance further comprises:
a token type, a balance of the token type, a cumulative deposit total of the token type, a sequence number, a creation date, and/or an expiration date.

12. The method of claim 11, wherein the token type comprises a token data structure instance, and the token data structure instance comprises: a token identity, a minimum token deposit amount, and a maximum token deposit amount.

13. The method of claim 12, wherein the token identity is a blockchain address of a smart contract instantiating the token type.

14. The method of any of claim 10, wherein the mapping comprises: a mapping from a transferor address to a mapping from a recipient address to a mapping from a channel number to a payment channel data structure instance.

15. The method of any of claim 10, wherein the mapping comprises: a mapping from a hash output of a transfer address, a recipient address and a channel number to a payment channel data structure instance.

16. The method of claim 11, wherein the token type is a fungible token.

17. The method of claim 11, wherein the token type is a non-fungible token (NFT).

18. The method of claim 11, wherein the token type is a cryptocurrency.

19. The method of claim 9, wherein the payment channel data structure instance comprises a plurality of token types.

20. The method of claim 1, wherein the digitally signed voucher is represented by one or more of:
binary data, a string, a quick-response code (QR code), a base64 encoded string, an array, an extended markup language (XML) file, and/or a JavaScript object notation (JSON) file.

21.
